(19) United States
(12) Patent Application Publication
(10) Pub. No.: US 2020/0049643 A1
(43) Pub. Date: Feb. 13, 2020

(54) TEMPERATURE AND HUMIDITY SENSOR MODULE HEAT DRYING STRUCTURE

(71) Applicant: SOLTEAM OPTO, INC., Taoyuan (TW)

(72) Inventors: Shang-Jung WU, Taoyuan (TW); Chun-Lin LU, Taoyuan (TW); Chia-Hung WANG, Taoyuan (TW); Chin-Feng CHEN, Taoyuan (TW)

(21) Appl. No.: 16/168,116

(22) Filed: Oct. 23, 2018

(30) Foreign Application Priority Data
Aug. 7, 2018 (TW) 107210793

(51) Int. Cl. G01N 27/12; G01K 7/24

(52) U.S. Cl. CPC G01N 27/123; G01K 7/24; G01N 27/121

(57) ABSTRACT

A temperature and humidity sensor module heat drying structure used in an electrical product is disclosed to include a temperature and humidity sensor, a heating element and a micro control unit. When the humidity value detected by the temperature and humidity sensor surpasses a predetermined reference value, the micro control unit controls the heating element to heat the temperature and humidity sensor, evaporating water from the surface of the temperature and humidity sensor. After a period of time, when the humidity value detected by the temperature and humidity sensor is lower than the predetermined reference value, the heating operation is stopped, keeping the temperature and humidity sensor in optimal working condition.

This application claims the priority benefit of Taiwan patent application number 107210793, filed on Aug. 7, 2018.

### BACKGROUND OF THE INVENTION

### 1. Field of the Invention

The present invention relates to temperature and humidity sensor technology and more particularly, to a temperature and humidity sensor module heat drying structure, which uses a microcontroller-controlled heater to heat a temperature and humidity sensor module, evaporating water from the surface of the temperature and humidity sensor module.

### 2. Description of the Related Art

The advancement of technology is to bring people a more comfortable and convenient life. This is the reason why 3C products or home appliances are constantly being introduced. Washing is a chore for people both at home and abroad, such as laundry or washing dishes. Wrinkles will occur when hands are in contact with water for a long time. Long-term contact with detergent will cause some damage to the skin of the hands. People naturally go to research and develop electric appliances, such as washing machines and dishwashers for handling things that people do not like to do. In particular, the dishwasher is a late-developed electrical product. Its cleaning ability and water-saving function are gradually recognized by the general consumers. Although the current price is still high, it is still a hot product on the market.

In the operation of a dishwasher, it is to put the dishes to be cleaned into a washing tank, and at the same time, to put appropriate detergent in the dishwasher. Thereafter, the operator operates the operation panel to set the cleaning temperature, cleaning time and cleaning mode (automatic, energy saving, strong). At this time, you can wait for the tableware to be automatically cleaned and dried. However, in order to achieve these functions, a temperature and humidity sensor must be set in the dishwasher to monitor the temperature and humidity of the cleaning tank, and the detected temperature and humidity data are transmitted back to a micro control unit for judgment and processing to complete the cleaning process. However, since the temperature and humidity sensor is disposed in a high humidity or splashing environment for a long time, it is easy to be covered by water molecules, which will cause the accuracy of the temperature and humidity sensor to be greatly reduced or even invalid. How to keep the temperature and humidity sensor in the best working condition becomes the problem that the present invention wants to solve.

### SUMMARY OF THE INVENTION

The present invention has been accomplished under the circumstances in view. It is therefore the main object of the present invention to provide a temperature and humidity sensor module heat drying structure for use in an electrical product, wherein when the humidity value detected by a temperature and humidity sensor in the electrical product surpasses a predetermined reference value, a micro control unit controls a heating element to heat the temperature and humidity sensor, evaporating water from the surface of the temperature and humidity sensor. After a period of time, when the humidity value becomes lower than the predetermined reference value, the heating operation is stopped, keeping the temperature and humidity sensor in an optimal working condition.

According to another aspect of the present invention, the micro control unit is electrically connected with the temperature and humidity sensor and the heating element by a serial transmission interface to get the best control.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a functional block diagram of a temperature and humidity sensor module heat drying structure in accordance with a first embodiment of the present invention.

FIG. 2 is a functional block diagram of a temperature and humidity sensor module heat drying structure in accordance with a second embodiment of the present invention.

### DETAILED DESCRIPTION OF THE PREFERRED EMBODIMENT

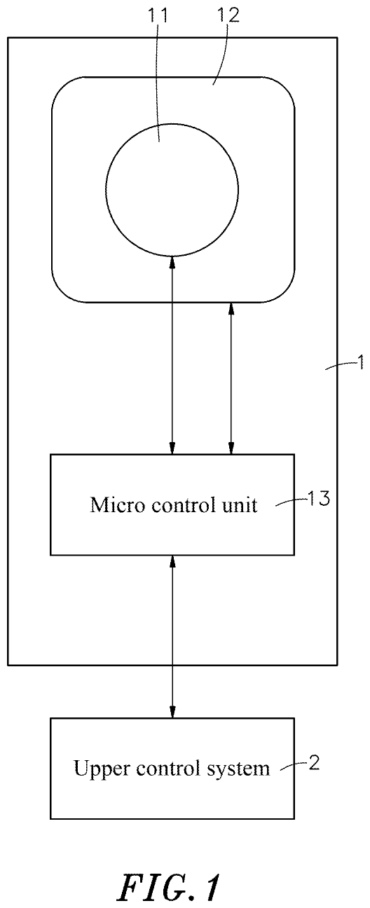

Referring to FIG. 1, a functional block diagram of a temperature and humidity sensor module heat drying structure in accordance with a first embodiment of the present invention is shown. As illustrated, a temperature and humidity sensor 11, a heating element 12 and a micro control unit (MCU) 13 are mounted on a circuit board 1. The detailed explanation of each component is as follows.

The temperature and humidity sensor 11 is mounted on the circuit board 1 and adapted for detecting the temperature and humidity of the outside world. Further, the temperature and humidity sensor 11 is composed of a resistive wet sensor and a thermistor.

The heating element 12 is mounted on the circuit board 1 around the outside of the temperature and humidity sensor 11 and adapted for heating the temperature and humidity sensor 11 to evaporate water from the surface of the temperature and humidity sensor 11. Further, in this embodiment, the heating element 12 is composed of an electrical heating plate.

The micro control unit 13 is mounted on the circuit board 1 and electrically connected with the temperature and humidity sensor 11 and the heating element 12 and used to control the operation of the heating element 12, and also to monitor whether the humidity value detected by the temperature and humidity sensor 11 is lower than a predetermined reference value. If the humidity value detected by the temperature and humidity sensor 11 is not lower than a predetermined reference value, it means that the temperature and humidity sensor 11 still has water molecules remaining on the surface thereof. At this time, the micro control unit 13 controls the heating element 12 to keep heating. If the humidity value detected by the temperature and humidity sensor 11 is lower than a predetermined reference value, it means that the surface of the temperature and humidity sensor 11 has been completely dried. At this time, the micro control unit 13 controls the heating element 12 to stop heating. The micro control unit 13 is electrically connected with the temperature and humidity sensor 11, the heating element 12 and an upper control system 2 by a serial transmission interface, and the serial transmission interface refers to an Inter-Integrated Circuit, I²C, a Serial Peripheral Interface Bus (SPI) or a Universal Asynchronous Receiver/Transmitter (UART).

The aforesaid upper control system 2 refers to the main control circuit of the electrical product, and the temperature and humidity sensor module heat drying structure disclosed in the present invention is only a branch circuit connected in series to the main control circuit, and the upper control system 2 and the micro control unit 13 can perform signal bidirectional transmission.

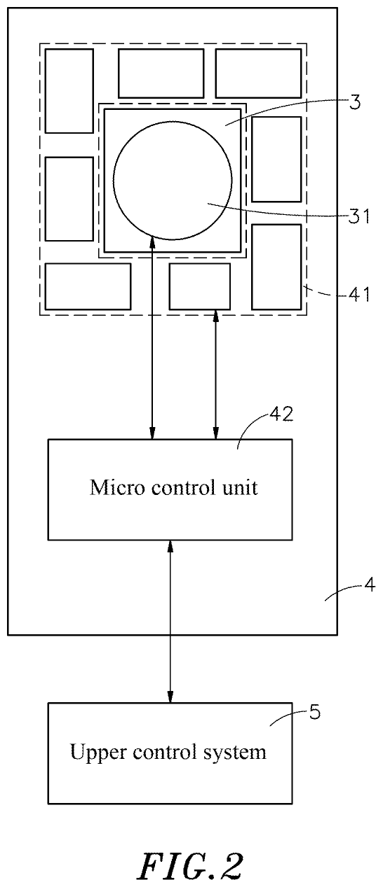

Referring to FIG. 2 a functional block diagram of a temperature and humidity sensor module heat drying structure in accordance with a second embodiment of the present invention is shown. As illustrated, a temperature and humidity sensor 31 is mounted on a first circuit board 3; a heating element 41 and a micro control unit (MCU) 42 are mounted on a second circuit board 4. The detailed explanation of each component is as follows.

The temperature and humidity sensor 31 is mounted on the first circuit board 3 and adapted for detecting the temperature and humidity of the outside world. Further, the temperature and humidity sensor 31 is composed of a resistive wet sensor and a thermistor.

The heating element 41 is mounted on the second circuit board 4 around the outside of the temperature and humidity sensor 31 and adapted for heating the temperature and humidity sensor 31 to evaporate water from the surface of the temperature and humidity sensor 31. Further, in this embodiment, the heating element 41 is composed of an electrical heating plate.

The micro control unit 42 is mounted on the second circuit board 4 and electrically connected with the temperature and humidity sensor 31 and the heating element 41 and adapted for controlling the heating operation of the heating element 41, and also to monitor whether the humidity value detected by the temperature and humidity sensor 31 is lower than a predetermined reference value. If the humidity value detected by the temperature and humidity sensor 31 is not lower than a predetermined reference value, it means that the micro control unit 42 controls the heating element 41 to keep heating. If the humidity value detected by the temperature and humidity sensor 31 is lower than a predetermined reference value, it means that the micro control unit 42 controls the heating element 41 to stop heating. The micro control unit 42 is electrically connected with the temperature and humidity sensor 31, the heating element 41 and an upper control system 5 by a serial transmission interface, and the serial transmission interface refers to an Inter-Integrated Circuit, I²C, a Serial Peripheral Interface Bus (SPI) or a Universal Asynchronous Receiver/Transmitter (UART).

The aforesaid upper control system 5 refers to the main control circuit of the electrical product, and the temperature and humidity sensor module heat drying structure disclosed in the present invention is only a branch circuit connected in series to the main control circuit, and the upper control system 5 and the micro control unit 42 can perform signal bidirectional transmission.

The embodiment shown in FIG. 2 illustrates that the temperature and humidity sensor 31 is mounted on the first circuit board 3; the heating element 41 and the micro control unit 42 are mounted on the second circuit board 4; the first circuit board 3 is embedded in the second circuit board 4. The advantage of this arrangement is that if the temperature and humidity sensor 31 fails or is defective, the first circuit board 3 can be replaced without the need of replacing the second circuit board 4, thereby saving the cost. Relatively, if the heating element 41 or the micro control unit 42 fails or is defective, the second circuit board 4 can be replaced without the need of replacing the first circuit board 3. This makes it possible to change the circuit design at the lowest cost.

By the disclosure of the first and second figures, you can understand the temperature and humidity sensor module heat drying structure provides a temperature and humidity sensor to work with a micro control unit in an electrical product. When the detected humidity value surpasses a predetermined reference value, a heating element is controlled by the micro control unit to heat the temperature and humidity sensor, evaporating water from the surface of the temperature and humidity sensor. After a period of time, when the humidity value detected by the temperature and humidity sensor is lower than the predetermined reference value, the heating operation is stopped, keeping the temperature and humidity sensor in optimal working condition. The technical measure of the present invention is practical for use in an electrical product with a temperature and humidity sensor, having the advantage of maintaining the temperature and humidity sensor in the best accurate working state.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A temperature and humidity sensor module heat drying structure, comprising:
a circuit board;
a temperature and humidity sensor mounted on said circuit board and adapted for detecting the temperature and humidity of the outside world;
a heating element mounted on said circuit board around an outside of said temperature and humidity sensor and adapted for heating said temperature and humidity sensor to evaporate water from the surface of said temperature and humidity sensor; and
a micro control unit mounted on said circuit board and electrically connected with said temperature and humidity sensor and said heating element, and adapted for controlling the heating operation of said heating element and monitoring the humidity value detected by said temperature and humidity sensor to be lower than a predetermined reference value or not, where said micro control unit controls said heating element to keep heating if the humidity value detected by said temperature and humidity sensor is not lower than said predetermined reference value, or controls said heating element to stop heating if the humidity value detected by said temperature and humidity sensor is lower than said predetermined reference value.

2. The temperature and humidity sensor module heat drying structure as claimed in claim 1, wherein said micro control unit is electrically connected with said temperature and humidity sensor and said heating element by a serial transmission interface.

3. The temperature and humidity sensor module heat drying structure as claimed in claim 2, wherein said serial transmission interface is selectively an Inter-Integrated Circuit, I²C, a Serial Peripheral Interface Bus (SPI) or a Universal Asynchronous Receiver/Transmitter (UART).

4. The temperature and humidity sensor module heat drying structure as claimed in claim 1, wherein said temperature and humidity sensor is composed of a resistive wet sensor and a thermistor.

5. The temperature and humidity sensor module heat drying structure as claimed in claim 1, wherein said heating element is composed of an electrical heating plate.

6. A temperature and humidity sensor module heat drying structure, comprising:
a first circuit board;
a second circuit board electrically connected with said first circuit board;
a temperature and humidity sensor mounted on said first circuit board and adapted for detecting the temperature and humidity of the outside world;
a heating element mounted on said second circuit board around an outside of said temperature and humidity sensor and adapted for heating said temperature and humidity sensor to evaporate water from the surface of said temperature and humidity sensor; and
a micro control unit mounted on said second circuit board and electrically connected with said temperature and humidity sensor and said heating element, and adapted for controlling the heating operation of said heating element and monitoring the humidity value detected by said temperature and humidity sensor to be lower than a predetermined reference value or not, where said micro control unit controls said heating element to keep heating if the humidity value detected by said temperature and humidity sensor is not lower than said predetermined reference value, or controls said heating element to stop heating if the humidity value detected by said temperature and humidity sensor is lower than said predetermined reference value.

7. The temperature and humidity sensor module heat drying structure as claimed in claim 6, wherein said micro control unit is electrically connected with said temperature and humidity sensor and said heating element by a serial transmission interface.

8. The temperature and humidity sensor module heat drying structure as claimed in claim 7, wherein said serial transmission interface is selectively an Inter-Integrated Circuit, I²C, a Serial Peripheral Interface Bus (SPI) or a Universal Asynchronous Receiver/Transmitter (UART).

9. The temperature and humidity sensor module heat drying structure as claimed in claim 6, wherein said temperature and humidity sensor is composed of a resistive wet sensor and a thermistor.

10. The temperature and humidity sensor module heat drying structure as claimed in claim 6, wherein said heating element is composed of an electrical heating plate.
